(19) United States
(12) Patent Application Publication
(10) Pub. No.: US 2001/0056141 A1
(43) Pub. Date: Dec. 27, 2001

(54) Non-aqueous coating compositions formed from silanes and metal alcoholates

(76) Inventor: John B. Schutt, Silver Spring, MD (US)

Correspondence Address: SHERMAN & SHALLOWAY, 413 North Washington Street, Alexandria, VA, 22314, US

(21) Appl. No.: 09/778,941

(22) Filed: Feb. 8, 2001

Related U.S. Application Data
(60) Provisional application No. 60/185,367, filed on Feb. 28, 2000.

(51) Int. Cl. C08K 5/24; C08K 3/34; C08K 3/38; C08K 3/10

(52) U.S. Cl. 524/261; 524/492; 524/405; 524/437

(57) ABSTRACT

A non-aqueous coating composition is obtained by mixing (A) at least one silane, such as phenyltrimethoxysilane, methyltrimethoxysilane; and (B) vinyltriacetoxy silane and/or colloidal aluminum hydroxide and/or at least one metal alcoholate. Optional additives include ethyl orthosilicate, ethyl polysilicate or colloidal silica in a lower alkanol and boric acid, which may be dissolved in a lower alkanol. Hard corrosion resistant coatings, which are substantially transparent, are obtained. These coatings may be applied to metallic or non-metallic surfaces.

### CROSS-REFERENCE TO RELATED APPLICATIONS

This application claims priority from Provisional Application No. 60/185,367, filed Feb. 28, 2000.

### BACKGROUND OF THE INVENTION

1. Field of the Invention

This invention relates to protective coating compositions. More particularly, this invention relates to non-aqueous oligomeric silicon coating compositions which, when applied to various substrates, provide a hard corrosion resistant coating. The compositions and the coating formed therefrom are substantially transparent.

2. Discussion of the Prior Art

U.S. Pat. Nos. 3,944,702, 3,976,497, 3,986,997 and 4,027,073 describe coating compositions, which are acid dispersions of colloidal silica and hydroxylated silsequioxane in an alcohol-water medium.

U.S. Pat. No. 4,113,665 discloses chemically resistant ambient curable coatings based on a binder of which the major portion is prepared by reacting, in an acidic solution, trialkoxysilanes (e.g., methyltriethoxysilane) with aliphatic polyols, silicones or both. Barium fillers, such as barium metaborate, may be added to provide resistance to sulfur dioxide. Zinc oxide or metallic zinc may be included for further corrosion resistance. The compositions may be applied to, e.g., steel petroleum tanks, by spraying, concrete, vitreous surfaces.

U.S. Pat. No. 4,413,086 describes water reducible coating compositions containing organosilane-polyol which is a reaction product between certain hydrophilic organic polycarbinols and organosilicon material, e.g., organosilane, curing agent (e.g., aminoplast resin), organic solvent (optional), essentially unreacted polyol (optional), essentially unreacted hydrolyzed and condensed organosilane (optional), water (optional) and pigment (optional).

U.S. Pat. No. 4,648,904 describes an aqueous emulsion of (a) hydrolyzable silane, inclusive of methyltrimethoxysilane, (b) surfactant (e.g., Table I, col. 4) and (c) water. The coatings may be used for rendering masonry water repellant.

U.S. Pat. No. 5,275,645 is purported to provide an improvement to the acid-catalyzed organosilane coating compositions of the above-mentioned U.S. Pat. No. 4,113,665. According to this patent a protective coating is obtained at ambient temperature from a coating composition containing organosilanes having an Si-O bond, using an amine catalyst and an organometallic catalyst.

U.S. Pat. No. 5,879,437 describes a coating composition containing a tetraalkyl silicate or monomeric or oligomeric hydrolysis product thereof, present in a proportion of 40-90% by weight based on the non-volatile content of the composition and a hydrous oxide sol (Type A or Type B), in an amount such that the oxide constitutes 10-60% by weight of the non-volatiles. According to the patentees, this coating composition is suitable for the pretreatment of solid surfaces such as metals generally, including steel, titanium, copper, zinc and, particularly aluminum, to improve adhesion properties of the pretreated surface to subsequently applied coatings, such as paint, varnish, lacquer; or of adhesive, either in the presence or absence of a lubricant.

U.S. Pat. No. 5,939,197 describes sol-gel coated metals, especially titanium and aluminum alloys. The sol-gel coating provides an interface for improving adhesion, through a hybrid organometallic coupling agent at the metal surface, between the metal and an organic matrix resin or adhesive. The sol is preferably a dilute solution of a stabilized alkoxyzirconium organometallic salt, such as tetra-i-propoxy-zirconium, and an organosilane coupling agent, such as 3-glycidyloxypropyltrimethoxysilane, with an acetic acid catalyst.

U.S. Pat. No. 5,954,869 discloses an antimicrobial coating from water-stabilized organosilanes obtained by mixing an organosilane having one or more hydrolyzable groups, with a polyol containing at least two hydroxyl groups. This patent includes a broad disclosure of potential applications and end uses, e.g., column 4, lines 35-53; columns 23-25.

U.S. Pat. No. 5,959,014 relates to organosilane coatings purported to have extended shelf life. Organosilane of formula RₙSiX₄₋ₙ (n=0-3; R=non-hydrolyzable group; X=hydrolyzable group) is reacted with a polyol containing at least three hydroxyl groups, wherein at least any two of the at least three hydroxyl groups are separated by at least three intervening atoms.

In my recently issued U.S. Pat. No. 5,929,129, there are described corrosion resistant coatings provided by aqueous-alcoholic dispersions of the partial condensate of monomethyl silanol (obtained by hydrolysis of monomethyl alkoxysilane) alone or in admixture with minor amounts of other silanol, e.g., gamma-glycidyloxy silanol, wherein the reaction is catalyzed by divalent metal ions, e.g., Ca⁺², typically from alkaline earth metal oxides. When these coating are applied to, e.g., boat hulls, such as aluminum hulls, they are highly effective in preventing corrosion from salt water for extended periods.

U.S. Pat. No. 4,463,114 discloses antistatic films based on aqueous hydroxyorganosilane compositions of which 1 to 95 wt. % may be a hydrolyzate of a hydroxyorganosilane and up to 50 wt. % may be a silanolsulfonate compound.

U.S. Pat. No. 4,804,701 discloses compositions based on fluorinated polymers in aqueous dispersion, having a basic pH, containing alkoxysilane and magnesium and/or aluminum as cations, complexed with amino- or hydroxycarboxy acids, acting as bonding agents, suitable to constitute a highly adhesive layer, on metal surfaces, in particular, as a primer.

U.S. Pat. No. 4,871 discloses ionomeric silane coupling agents used in bonding a matrix polymer to a mineral substrate.

### SUMMARY OF THE INVENTION

This invention provides a composition suitable as a corrosion control coating for metals, and a water diffusion control coating for concrete and fiberglass reinforced plastics. The coating compositions may be applied to, for example, aluminum and steel cans containing solid or liquid foods and beverages.

This invention also provides abrasion resistant coating compositions suitable for metallic and nonmetallic surfaces.

In another aspect, the invention provides a transparent and impervious glass or silica layer fastened by chemical bonding to a metallic surface, which is over coated by a copolymeric silicone layer.

In a specific embodiment, this invention provides a coating composition suitable for coating concrete.

A further specific embodiment of this invention is a coating composition sutiable for marine surfaces, such as aluminum boat hulls and assorted brass, bronze and steel fixtures found in the marine environment, to render surfaces resistant to corrosion in a salt water environment.

In still another embodiment of the invention, a non-aqueous coating composition which is especially effective in providing clear, hard, strongly adherent corrosion resistant coatings for glass substrates and for providing clear, hard, glossy and slick (slippery or wax-like) adherent corrosion resistant coatings for metal substrates is provided.

These various embodiments of the invention may be achieved by a non-aqueous coating composition, adapted to the coating of various substrates, including, concrete, metal and non-metallic substrates, formed by admixing

(A) at least one silane of formula (1)

R¹ₙSi(OR²)₄₋ₙ (1)

wherein R¹ represents a lower alkyl group, a phenyl group or a functional group containing at least one of vinyl, acrylic, amino, mercapto, or vinyl chloride functional groups;

R² represents a lower alkyl group; and,

n is a number of 1 to 2; and

(B) at least one compound selected from the group consisting of

(i) vinyltriacetoxysilane and/or

(ii) colloidal aluminum hydroxide and/or

(iii) at least one metal alcoholate of formula (2)

M(OR³)ₘ (2)

wherein M represents a metal of valence m,

R³ represents a lower alkyl group, and

m is a number of 2 to 4.

The embodiment of the invention, particularly adapted to providing a coating composition for steel, may be accomplished by a non-aqueous coating composition formed by admixing components (A) and (B), as set forth above, and components (C) and (D), as follows:

(C) at least one silica component selected from the group consisting of methyl orthosilicate, ethyl orthosilicate, ethylpolysilicate and colloidal silica dispersed in lower alcohol; and

(D) an acid component selected from the group consisting of boric acid and boric acid dissolved in lower alcohol.

The embodiment of the invention, particularly adapted to overcoat alkali metal silicate coatings may be provided by a non-aqueous coating composition formed by admixing components (A), (B) and (D), as set forth above, with the proviso that a mixture of silane compounds of formula (1) is used, wherein at least one silane compound wherein R¹ represents γ-glycidyloxypropyltrimethoxy is present in the mixture.

The embodiment of the invention, particularly adapted to provide non-adherent surfaces, may be accomplished by a non-aqueous coating composition formed by admixing components (A) and (B), as set forth above, and (E) finely divided solid lubricant.

The embodiment of the invention for providing clear, hard coatings for glass substrates and slick, glossy coatings for metal substrates, may be formed by using a mixture of silane compounds of formula (1) wherein R¹ in one silane compound is lower alkyl and in another silane compound R¹ is aryl, especially phenyl. The composition may further include a small amount of (F) calcium hydroxide which functions, on glass, as an abrasive agent and etchant, and a silicate component (C), preferably, partially hydrolyzed silicate, especially a hydrolysis product of tetraethylsilicate.

### DETAILED DESCRIPTION AND PREFERRED EMBODIMENTS

The non-aqueous coating compositions of the present invention may be broadly described as non-aqueous coating compositions of oligomeric siloxane binder and a catalyst which promotes hydrolysis and which can become an integral part of the siloxane network.

The invention compositions may be prepared by combining the ingredients in a single container by simple mixing. When applied to a receptive substrate, the mixture hydrolyzes thereon and chemically attaches to the substrate while simultaneously forming a strongly adherent film coating. Because the mixture of film formers is water-free when applied, mixing creates a one container system and shelf life generally does not present a problem. Attaining a tack-free state, followed by cure, can occur in about two hours for most formulations. However, since the components react with ambient moisture, care must be taken to avoid contact with such moisture prior to actual mixing and use. Any conventional technique for moisture avoidance may be utilized, e.g., vacuum packaging, hermetic seals, etc.

The nonaqueous coating composition, when applied to a receptive surface of a substrate will form a hard, abrasion resistant, flexible, and generally transparent, and corrosion resistant surface coating. The composition may be applied by any suitable technique, e.g., spraying, dipping, brushing, wiping, and the like, using automatic or manual applicators. Because the mixture has the potential to chemically bond to a metallic surface and selected dielectrics, proper surface preparation should be performed prior to applying the coating composition. Vapor degreasing is useful fro mixtures containing not more than about 15% ethyl silicate. At greater levels, grit blasting and/or treating with an acidic cleaning agent, which may optionally be included in the composition itself, may be necessary. Most embodiments of the invention become tack-free in less than two hours. Curing can be accelerated by applying heat to a level of, for example, about 80° C.

The resulting coated articles have strongly adherent, non-porous transparent protective surface coatings, which, depending on the porosity of the substrate, may extend from about several mils below the surface for smooth surface materials, e.g., metals, to throughout the entirety or majority of porous substrates, such as, concrete.

In the silanes of formula (1) R¹ is alkyl, preferably, a C₁-C₆ alkyl group (the group may be a straight, cyclic, or branched-chain alkyl), such as methyl, ethyl, n- or iso-propyl, n- or iso-butyl, n-pentyl, cyclohexyl, and the like, preferably a C₁-C₄ alkyl group, most preferably a methyl, ethyl, propyl or butyl group), aryl, such as a phenyl, or a functional group or groups, such as vinyl, acrylic, methacrylic, amino, mercapto, or vinyl chloride functional group, e.g., 3,3,3-trifluoropropyl, γ-glycidyloxypropyl, γmethacryloxypropyl, N-(2-aminoethyl)-3-aminopropyl, aminopropyl, and the like; and each R² is, independently, an alkyl group (i.e. a C₁-C₆ straight or branched chain alkyl group, preferably a C₁-C₄ alkyl group, such as a methyl group).

As examples of silanes of formula (1), wherein R¹ is an alkyl group or aryl group, and n is 1, mention may be made of, for example, methyltrimethoxysilane, ethyltrimethoxysilane, ethyltriethoxysilane, n-propyltrimethoxysilane, n-propyltriethoxysilane, isopropyltrimethoxysilane, n-butyltrimethoxysilane, isobutyltrimethoxysilane, phenyltrimethoxysilane, preferably Methyltrimethoxysilane, phenyltrimethoxysilane, and mixtures thereof. In the case where R¹ is a functional group, mention may be made, for example, of N-(2-aminoethyl)-3-aminopropyltrimethoxysilane, 3-mercaptopropyltrimethoxysilane, 3-mercaptopropyltriethoxysilane, 3-aminopropyltriethoxysilane, 3-(meth)acryloxypropyltrimethoxysilane, 3-(meth)acryloxypropyltriethoxysilane, n-phenylaminopropyltrimethoxysilane, vinyltriethyoxysilane, vinyltrimethoxysilane, allyltrimethoxysilane, γ-glycidyloxypropyltrimethoxysilane, and the like, and any of the aminosilane catalysts, described herein below.

When n is 2, the silane compounds may be represented by, for example, dimethyldimethoxysilane, diethyldimethoxysilane, diphenyldimethoxysilane, methylethyldimethoxysilane, divinyldimethoxysilane, methyl-γ-glycidyloxypropyl-dimethoxysilane, and the like.

As used herein, the expression “functional group” is intended to include any group, other than hydroxyl, (including alkoxy, aryloxy, etc.), which is hydrolyzable to provide, in situ, a reactive group (e.g., reactive hydrogen) which will react, in other than a condensation reaction, with the substrate (e.g., metal), itself, or other reactive components in or from the coating composition. The functional groups, in addition to the hydroxyl group (by hydrolysis of the (OR²) groups), tend to form three-dimensional or cross-linked structure, as well known in the art.

Moreover, in the various embodiments of the invention, it is often preferred to use mixtures of two or more silane compounds of formula (1). Mixtures of at least phenyltrimethoxysilane and methyltrimethoxysilane are often especially preferred.

Generally, total amounts of silane compounds of formula (1) will fall within the range of from about 50 to about 99.6 percent by weight, preferably from about 60 to about 98 percent by weight, more preferably, from about 70 to about 97.5%, by weight, based on the total weight of the composition.

The component (B) functions as a catalyst for the silane component (A). For metal alcoholates (B)(ii), represented by the following formula (2):

M(OR³)ₘ (2)

where M is a metal of valence m (namely, from Groups IIIA, IVA, IIB or IVB of the periodic table of the elements), e.g., boron, titanium, aluminum, indium, yttrium, cerium, lanthanum, silicon, tin, hafnium, etc; boron, aluminum and titanium are especially preferred because the alkoxides of these metals are more readily commercially available, and tend to be non-toxic.

R³ is a lower alkyl group, e.g., C₁-C₆ straight or branched chain alkyl group, preferably C₂-C₄ alkyl group, most preferably, isopropyl, isobutyl or n-butyl.

As specific examples of the metal alcoholates of formula (2), mention may be made of metal alcoholates of C₂-C₄ alkanols, e.g., titanium tetraisopropoxide (also may be referred to as tetraisopropoxy titanate), titanium tetrabutoxide, aluminum triisopropoxide, zinc diisopropoxide, zinc di-n-butoxide, calcium diisopropoxide, calcium di-isobutoxide, boron triisopropoxide, boron triisobutoxide, and the like.

In addition, double metal alcoholates of, for example, AlTi, AlZr, AlY, MgAl, MgTi, MgZr, etc., may also be used.

Mixtures of two or more metal alcoholates, and mixtures of metal alcoholate(s) with vinyltriacetoxysilane and/or colloidal aluminum hydroxide, or mixture of vinyltriacetoxysilane with colloidal aluminum hydroxide, may also be used as the component (B).

The presence of the trivalent and tetravalent metal ions are especially useful for coating compositions applied to steel since they tend to form insoluble (water and alkali) iron silicates, whereas the products of divalent metals, tend to be soluble. Tetraisopropoxy titanate is especially preferred as component (B).

Generally, total amounts of component (B) will be in the range of from about 0.4 to about 10% by weight, preferably, from about 0.6 to about 4%, by weight, based on the total weight of the composition.

Depending on the particular application one or more additional components can be added to the compositions of this invention. For example, in the case of application of the coating composition to steel surfaces, it is preferred to include components (C) and (D).

Component (C) is a silica component which may be methylorthosilicate, ethylorthosilicate, polyethylsilicate or colloidal silica. These silicates may be hydrolyzed, for example, from about 28% to about 52% silica. Especially preferred in this regard is tetraethylsilicate (TEOS) which has been subjected to controlled hydrolysis, providing a mixture of TEOS and, from about 20% to about 60% polydiethoxysilane oligomers. For example, a 50% hydrolysis product may be referred to herein as “polydiethoxysilane (50%).” When colloidal silica is used, it will be present in an appropriate solvent medium, preferably a lower alkanol, such an isopropanol.

Generally, total amounts of silicate component (C), when used, will fall within a range of from 0.1 to about 50 percent by weight, preferably from 0.4 to about 45 percent by weight, more preferably, from about 2 to about 44 wt. %, based on the total composition.

Component (D) is an inorganic acid, especially boric acid, H₃BO₃, (which may be dissolved in a solvent, such as lower (C₁ to C₆, preferably C₁ to C₄, alcohol, e.g., isopropanol). However, other inorganic acids, such as phosphorous acid, H₃PO₃, may also be used, in place of some or all of the boric acid. In some cases, however, aliphatic acids, such as lower alkanoic acids, e.g., formic acid, acetic acid, propanoic acid, butyric acid, especially acetic acid for reasons of safety and cost.

Suitable amounts of boric acid component (D), when present, will generally be within a range of from about 5 to about 50 wt. %, preferably, from about 8 to about 40 wt. %, based on the total weight of the composition.

For application as an overcoating for alkali metal silicate coatings, the coating composition of this invention will preferably include component (A) silane of formula (1), which will include γ-glycidyloxypropyltrimethoxysilane and at least one other silane of formula (1), especially methyltrimethoxysilane or mixture of methyltrimethoxysilane and phenyltrimethoxysilane. The component (D), boric acid (or solution thereof in lower alkanol, will also usually be included. Component (C) silicate may also be present in the composition. Suitable amounts of γ-glycidyloxypropyltrimethoxy silane will generally fall within a range of from about 2 to about 25 wt. %, preferably from about 5 to 20 wt. %, based on the total composition. Usually, the total amount of silane compounds of formula (1) to form a silicate overcoating will fall within the ranges specified above for the silane of formula (1).

For use of the coating compositions to form non-adherent, corrosion resistant, surfaces, component (E), which is a finely divided solid lubricant, e.g., graphite, molybdenum disulfide, polytetrafluoroethylene, and the like, may be used. Mixtures of these solid lubricants are also useful.

When present, the amount of component (E), solid lubricant, will fall within a range of from about 5 to about 40 wt. %, preferably from about 7 to 30 wt. %, especially, from about 10 to about 28 wt. %, based on the total composition. Within these ranges, the desired degree of adhesion resistance (e.g., to render the coated surface resistant to adhesion of, for example, marine organisms, e.g., barnacles, algae, and the like, organic substances, such as, for example, oils, greases, paints, inks and the like) will be obtained, without impairing other desired properties or curability of the composition.

In the case of coating compositions for providing clear, hard and glossy finishes, for, e.g., glass or steel, it is preferred to include component (F) calcium hydroxide, which serves as an abrasive agent and etchant and component (C) silicate, in addition to a mixture of tri- or di-alkyloxysilanes and tri-or di-aryloxysilanes, preferably, trialkoxysilane and triaryloxysilane, according to formula (1). In this case, the amount of (F) calcium hydroxide, may suitably be in a range of from about 0.1 to about 5 parts by weight, preferably, from about 0.5 to about 3 parts by weight, especially, from about 0.8 to about 2.5 parts by weight, based on the total weight of components (A), (B), (C), (D), (E) and (F).

Although the non-aqueous compositions of the present invention are often formulated without addition of solvent, or with solvent added only as a component of another ingredient, e.g., (C) silica dispersion in lower alcohol, (D) boric acid solution in lower alkanol, etc, it is also within the scope to formulate the subject compositions as solvent-based compositions, by separately adding (G) solvent. When present in the compositions of this invention, whether added separately, or as part of another ingredient, total amounts of solvents will usually fall within a range of from about 0 to 1000 parts, preferably from about 0 to about 800 parts by weight, based on the total weight of the composition. In particular, solvent (G) will be included in the case of the formulations for providing hard, clear and glossy corrosion resistant coatings for glass, to facilitate the application of the coating by wiping with a sponge or cloth.

As examples of organic solvents, mention may be made of lower alkanol, e.g., C₂-C₄ alkanols, preferably isopropanol. Other organic solvents, such as, for example, acetone, methyl ethyl ketone, ethyl acetate, and the like may also be used.

Generally, total amounts of organic solvent, such as, lower alkanol, will fall within a range of from 0 to about 50 percent by weight, preferably from 0 to about 30 percent by weight, based on the total weight of components (A)-(F). In some cases, however, such as the glossy glass and metal coating compositions, substantially higher amounts may be convenient, especially where, for example, the coating compositions are applied by spraying as an aerosol or mist or otherwise where a lower viscosity is desireable.

According to the present invention, the non-aqueous composition capable of providing hard, glossy, corrosion resistant films may be provided on various substrates, such as glass window (particularly, the outside surface of the glass window), or to the painted finish of an automobile, by wiping with a brush, sponge, or soft cloth. After allowing the alcohol to evaporate, leaving a whitish or chalky finish, due to the Ca(OH)₂ particles deposited on the surface, the coating is polished to provide a highly transparent hard adherent finish. When applied to a painted metal surface, such as an automobile, the coating becomes slick and glossy, providing a highly durable finish, much superior to known wax finishes. For optimum results, it may be and generally is necessary to thoroughly pre-clean the surface to be coated.

Within the above general amounts and proportions, and when used in any of the various embodiments, preferred amounts (parts by weight) of the respective ingredients usually fall within the following ranges (based on a total of 100 parts by weight of the composition): silane component (A) from about 15 to about 25 parts of methyltrimethoxysilane, from about 1 to about 5 parts of phenyltrimethoxysilane, from about 0.3 to about 3 parts γ-glycidyloxypropyltrimethoxysilane; catalyst component (B) from about 0.2 to about 0.5 parts; silicate component (C) from about 0.2 to about 1 part; boric acid component (D) from about 0.1 to about 1 part, as H₃BO₃; solid lubricant (E) from about 2.5 to 20 parts by weight.

While general and preferred ranges of amount for the film-forming and catalytic components have been described above, it will be recognized by those skilled in the art, that these amounts may be increased or decreased as necessity demands and that the optimum amounts for any particular end use application may be determined by the desired performance. In this regard, for example, when the amount of catalyst is reduced, the time to achieve freedom from tack will increase. Similarly, when the amount of the catalyst(s) is (are) increased, this may lead to increased rates of cracking, loss of adhesion and performance loss of the resulting coating.

The compositions of this embodiment may further include one or more additional additives for functional and/or esthetics effects, such as, for example, UV absorbers, co-solvents, such as, for example, mono-lower alkyl ether of alkylene (e.g., ethylene) glycol, and the like.

As examples of mono-lower alkyl ether of alkylene (e.g., ethylene) glycol, mention may be made of mono-C₁-C₆-alkyl ethers of ethylene glycol, such as, for example, monomethyl ether, monoethyl ether, monopropyl ether, monobutylether, monopentylether or monohexylether, preferably monoethyl ether of ethylene glycol.

As an example of ultra-violet light absorber, mention may be made of, for example, titanium dioxide in finely powdered form, e.g., having an average particle diameter of about 20 nm. Other inorganic or organic ultra-violet light absorbers may be utilized in so far as they do not interfere with the objects of this invention.

Generally, total amounts of the ultra-violet light absorber, when used, will fall within the range of from 0 to about 10 percent by weight, preferably from 0 to about 5 percent by weight, based on the total weight of components (A)-(F).

Generally, total amounts of the mono-lower alkyl ether of ethylene glycol, when used, will fall within the range of from 0 to about 15 percent by weight, preferably from 0 to about 6 percent by weight, based on the total weight of components (A)-(F).

The following examples are illustrative and are not intended to limit the invention in any way.

### EXAMPLE 1

5 parts by weight of phenyltrimethoxysilane and 2 parts by weight of γ-glycidyloxypropyltrimethoxysilane are added to a container containing 15 parts by weight of methyltrimethoxysilane and mixed. While mixing, 0.4 part by weight of tetraisopropoxytitanate is added. The resulting mixture may be applied to a concrete block by spraying. After curing for 24 hours, the pressure required to force water through the coating will be approximately 2400 pounds/square foot.

### EXAMPLE 2

5 parts by weight of isobutyltrimethoxysilane and 2 parts by weight of γ-glycidyloxypropyltrimethoxysilane are added to a container containing 15 parts by weight of methyltrimethoxysilane and mixed. While mixing, 0.2 part by weight of tetraisopropoxytitanate is added. The resulting mixture may be applied to a concrete block by spraying. After curing for 24 hours, the pressure required to force water through the coating will be approximately 2400 pounds/square foot.

### EXAMPLE 3

5 parts by weight of phenyltrimethoxysilane are added to a container containing 15 parts by weight of methyltrimethoxysilane and mixed. While mixing, 0.2 part by weight of tetrabutoxytitanate is added. 6.5 parts by weight of a saturated solution of boric acid in isopropyl alcohol is then added. The resulting mixture may be sprayed on brass to provide a hard, corrosion resistant transparent coating.

### EXAMPLE 4

5 parts by weight of phenyltrimethoxysilane are added to a container containing 15 parts by weight of methyltrimethoxysilane and mixed, followed by 0.2 part by weight of vinyltriacetoxysilane, to form a coating composition.

### EXAMPLE 5

5 parts by weight of phenyltrimethoxysilane are added to a container containing 15 parts by weight of methyltrimethoxysilane and mixed. While mixing, 0.2 part by weight of tetrabutoxytitanate is added, and 4 parts by weight of ethyl poly-silicate, hydrolyzed to 40% silica, and 0.2 part by weight of vinyltriacetoxysilane are subsequently added. The resulting mixture may be applied to aluminum and steel by spraying, brushing or dipping.

### EXAMPLE 6

5 parts by weight of phenyltrimethoxysilane are added to a container containing 15 parts by weight of methyltrimethoxysilane and mixed. While mixing, 0.2 part by weight of N-(2-aminoethyl)-3-propylaminotrimethoxysilane is added, followed by 0.3 part by weight of vinyltriacetoxysilane. The resulting mixture may be applied to aluminum by spraying, brushing or dipping.

### EXAMPLE 7

15 parts by weight of phenyltrimethoxysilane are added to a container containing a mixture of 1 part by weight of dimethyldimethoxysilane and 0.5 part by weight of diphenyldimethoxysilane. While mixing the silane compounds, 0.3 part by weight of colloidal aluminum hydroxide and 0.2 part by weight of titanium tetrabutoxide are added. The resulting mixture may be sprayed onto steel and aluminum to form hard, corrosion resistant transparent coatings.

### EXAMPLE 8

15 parts by weight of phenyltrimethoxysilane are added to a container containing a mixture of 1 part by weight of dimethyldimethoxysilane, 0.5 part by weight of diphenyldimethoxysilane, and 1.5 parts by weight of ethyl poly-silicate, previously hydrolyzed to 40% silica. 0.3 part by weight of boric acid powder is mixed in until dissolved following by 0.2 part by weight of titanium tetrabutoxide. Upon hydrolysis, the resulting mixture is sprayed onto steel and aluminum.

### EXAMPLE 9

To a mixture of 15 parts by weight of methyltrimethoxysilane, 1 part by weight of dimethyldimethoxysilane, 0.5 part by weight of diphenyldimethoxysilane and 1 part by weight of polyethylsilicate (40% silica), 0.3 part by weight of tetraisopropyltitanate is added, while stirring. After thorough mixing, 6.5 parts by weight of a saturated solution of boric acid in isopropyl alcohol is added. After an equilibration period of about an hour, the mixture can be applied to aluminum or steel.

### EXAMPLE 10

5 parts by weight of phenyltrimethoxysilane are added to a container containing 15 parts by weight of methyltrimethoxysilane and mixed. While mixing, 0.2 part by weight of tetraisopropoxytitanate is added. The resulting mixture is applied to a concrete block by spraying. After curing for 24 hours, the pressure required to force water through the coating is approximately 2400 pounds/square foot.

### EXAMPLE 10A

The procedure of Example 10 is repeated except that 0.3 parts of tetrabutoxytitanate is used instead of 0.2 parts of titanium tetraisopropoxytitanate. Similar results will be obtained.

Furthermore, after reaction (about 30 minutes) the above mixture is applied to brass by rubbing or spraying. The resulting coating is able to withstand 4000 hours in a salt water spray without being affected.

By increasing the amount of the metal alcoholate catalyst, for example, to 0.4 parts, the reaction time may be further reduced.

These examples show that the subject coating compositions with high solids content (i.e., 52% in Example 10A) provide very effective compositions. However, if desired, it is possible to add diluent, for example, lower alcohol, in small amounts, such as, for example, up to about 10 parts, to further reduce the viscosity of the composition, although, the properties of the resulting coatings may be somewhat diminished, especially at the higher dilutions.

When adding diluent, such as lower alcohol, it is recommended to first allow the silanes to undergo catalysis by the addition of the metal alcoholate, and then add the alcohol, as in a “three pot” system. The reason why the diluent, such as lower alcohol, is avoided, or added only after catalysis, is that the alcohol tends to act as scavengers to compete with the silanes for water necessary for completion of the reaction.

### EXAMPLE 11

5 parts by weight of methyltrimethoxysilane, 15 parts by weight of phenyltrimethoxy silane and 0.3 part by weight of titanium tetraisopropoxide are introduced into and mixed in a container. Next 0.6 part by weight of boric acid is dissolved in the mixture. After dissolution of the boric acid in the silane-containing mixture, 10 parts by weight of the ethyl polysilicate, previously hydrolyzed to 40% silica, are added thereto. The mixture is applied, by dipping, to steel, aluminum and brass coupons. After curing for 48 hours, the cured coatings are cross-hatched and immersed in a 12% aqueous HCl solution for 30 minutes. No creep is observed when the coupons are removed.

### EXAMPLE 12

5 parts by weight of phenyltrimethoxysilane are added to a container containing 15 parts by weight of methyltrimethoxysilane and mixed. While mixing, 0.2 part by weight of N-(2-aminoethyl)-3-aminopropyl silane is added, followed by 4 parts by weight of ethyl polysilicate, hydrolyzed to 40% silica. The resulting mixture is applied, by dipping, to steel, aluminum and brass coupons. Addition of acetic acid (0.2 to 0.6 part by weight) to this composition will extend the shelf life of the composition.

### EXAMPLE 13

5 parts by weight of phenyltrimethoxysilane are added to a container containing 15 parts by weight of methyltrimethoxysilane and mixed. While mixing, 0.2 part by weight of tetraisopropoxytitanate is added. Finally, 6.5 parts by weight of saturated solution of boric acid in isopropyl alcohol is added. The resulting mixture is sprayed on aluminum.

### EXAMPLE 14

5 parts by weight of phenyltrimethoxysilane are added to a container containing 15 parts of methyltrimethoxysilane and mixed. While mixing, 0.2 parts by weight of tetraisopropoxytitanate is added, followed by 0.2 part by weight of N-(2-aminoethyl)-3-aminopropyltrimethoxysilane and 0.2 part by weight of vinyltriacetoxy silane. The resulting mixture is applied to aluminum.

### EXAMPLE 15

15 parts by weight of methyltrimethoxysilane are added to a container containing a mixture of 0.4 part by weight of dimethyldimethoxysilane, 0.1 part by weight of diphenyldimethoxysilane and 1 part by weight of ethyl poly-silicate, hydrolyzed to about 40% silica, and mixed. While mixing, 0.4 part by weight of titanium tetraisopropoxide is added. The resulting mixture is sprayed onto steel and aluminum.

### EXAMPLE 16

19 parts by weight of methyltrimethoxysilane, 3.3 parts by weight of phenyltrimethoxysilane, 3.3 parts by weight of γ-glycidyloxypropyltrimethoxysilane, 0.2 part by weight of titanium tetrabutoxide and 6.5 parts by weight of a saturated solution of boric acid in isopropyl alcohol (forming boron isopropoxide) are combined. The resulting mixture is coated onto a potassium silicate coating. No delamination or osmotic blistering is found after 168 hours immersion in water.

### EXAMPLE 17

5 parts by weight of phenyltrimethoxysilane are added to a container containing 15 parts by weight of methyltrimethoxysilane and mixed. While mixing, 0.2 part by weight of tetraisopropoxy titanate is added, followed by 3.7 parts by weight of molybdenum disulfide. The resulting mixture is applied to the propeller of a boat by spraying. After curing for 72 hours, the boat is immersed in water and driven. The coating has the ablative properties to shed barnacles and maintain a slick surface.

### EXAMPLE 18

5 parts by weight of phenyltrimethoxysilane are added to a container containing 15 parts of methyltrimethoxysilane and mixed. While mixing, 0.2 part by weight of tetraisopropoxy titanate is added, followed by 3 parts by weight of graphite and 3.5 parts by weight of polytetrafluoroethylene. The resulting mixture is applied to the bottom of a boat by spraying. After curing for 72 hours, the boat is immersable in water. The resultant coating provides resistance to barnacle growth on a seasonal basis.

### EXAMPLE 19

5 parts by weight of phenyltrimethoxysilane are added to a container containing 15 parts of methytrimethoxysilane and mixed. While mixing, 0.2 part by weight of tetraisopropoxy titanate is added, followed by 12 parts by weight of graphite. The resulting mixture is applied to the interior of a pipe carrying water containing high levels of calcium to check the ability of the coating to retard calcium deposition. The resultant mixture is also applied to the bottom of a boat in the manner of Example 18. On a seasonal basis, the coating provides excellent resistance to barnacle growth.

### EXAMPLE 20

This example shows a formulation suitable for providing a salt, mildew and streak resistant coating for glass substrates, e.g., windows, especially in corrosive environment, such as in seaside dwellings.

To a container containing 600 parts of isopropyl alcohol there is added, while stirring, 24 parts of methyltrimethoxysilane and an equal amount of phenyltrimethoxysilane. To this mixture, there is added 6 parts of polydiethoxysiloxane (˜50% solids) and one part of calcium hydroxide. Stirring is continued until the mixture remains cloudy.

The resulting coating may be applied to a glass window substrate by, for example, wiping. After evaporation of isopropyl alcohol, the surface can be polished, using a soft cloth or sponge, until it feels slick to the touch. An additional application may be necessary under severe conditions. The surface may require washing (e.g., with a dilute aqueous surfactant). If necessary, residual coating may be removed from the window, etc. by scraping (e.g., with a razor blade) followed by rinsing with alcohol (e.g., isopropyl alcohol).

Similar results are obtained when this composition is applied to metal (e.g., aluminum, steel, galvanized steel) substrates.

What is claimed is:

1. A non-aqueous coating composition, useful for coating of concrete, metal and non-metallic substrates, formed by admixing
(A) at least one silane of formula (1)
R¹ₙSi(OR²)₄₋ₙ (1)
wherein R¹ represents a lower alkyl group, an aryl group or a functional group containing at least one of vinyl, acrylic, amino, mercapto, or vinyl chloride functional groups;
R² represents a lower alkyl group; and,
n is a number of 1 to 2; and
(B) at least one compound selected from the group consisting of
a. vinyltriacetoxysilane and/or
b. colloidal aluminum hydroxide and/or
c. at least one metal alcoholate of formula (2)
M(OR³)ₘ (2)
wherein M represents a metal of valence m,
R³ represents a lower alkyl group, and
m is a number of 2 to 4.

2. The non-aqueous composition according to claim 1, further comprising
(C) at least one silicate component selected from the group consisting of methyl orthosilicate, ethyl orthosilicate, ethylpolysilicate and colloidal silica dispersed in lower alcohol.

3. The non-aqueous composition according to claim 1, further comprising (D) an acid component selected from the group consisting of boric acid and boric acid dissolved in lower alcohol.

4. The non-aqueous composition according to claim 1, which comprises a mixture of silane compounds of formula (1), wherein at least one silane compound wherein R¹ represents γ-glycidyloxypropyl is present in the mixture.

5. The non-aqueous composition according to claim 1, which further comprises (E) finely divided solid lubricant.

6. The non-aqueous composition according to claim 1, wherein in formula (1), R¹ represents methyl, ethyl, propyl, phenyl, 3,3,3-trifluoropropyl, γ-glycidyl-oxypropyl, γ-methacryloxypropyl, N-(2-aminoethyl)-3-aminopropyl or aminopropyl.

7. The non-aqueous composition according to claim 1, wherein (B) vinyltriacetoxysilane is present.

8. The non-aqueous composition according to claim 1, wherein (B) colloidal aluminum hydroxide is present.

9. The non-aqueous composition according to claim 1, wherein metal alcoholate of formula (2) is present.

10. The non-aqueous composition according to claim 9, wherein the metal alcoholate of formula (2) comprises at least one compound selected from the group consisting of titanium tetraisopropoxide, titanium tetrabutoxide, aluminum triisopropoxide, zinc diisopropoxide, zinc di-n-butoxide, calcium diisopropoxide, calcium di-isobutoxide, boron triisopropoxide, and boron triisobutoxide.

11. The non-aqueous composition according to claim 1, wherein component (A) comprises a mixture of methyltrimethoxysilane and phenyltrimethoxysilane.

12. The non-aqueous composition according to claim 11, wherein component (B) comprises tetraisopropoxytitanate.

13. The non-aqueous composition according to claim 12, which comprises from about 15 to about 20 parts by weight of methyltrimethoxysilane, from about 1 to about 5 parts by weight of phenyltrimethoxysilane and from about 0.2 to about 0.5 parts by weight of tetraisopropoxytitanate.

14. The non-aqueous composition according to claim 1, wherein component (A) comprises a mixture of methyltrimethoxysilane, phenyltrimethoxysilane and N-(2-aminoethyl)-3-aminopropyltrimethoxysilane.

15. The non-aqueous composition according to claim 1, further comprising (C) at least one silicate component selected from the group consisting of methyl orthosilicate, ethyl orthosilicate, ethyl polysilicate and colloidal silica dispersed in a lower alcohol, and (D) an acid component selected from the group consisting of boric acid and boric acid dissolved in lower alcohol.

16. The non-aqueous composition according to claim 1, further comprising (F) calcium hydroxide, and wherein component (A) comprises a mixture of at least two silane compounds of formula (1), wherein R¹ in one silane compound is a lower alkyl group and R¹ in another silane compound is an aryl group.

17. The non-aqueous composition according to claim 16, wherein component (A) comprises a mixture of methyltrimethoxysilane and phenyltrimethoxysilane; and component (C) comprises partially hydrolyzed tetraethylsilicate.

18. The non-aqueous composition according to claim 17, further comprising (G) lower alcohol solvent.

19. The non-aqueous coating composition according to claim 15, wherein component (A) comprises a mixture of a silane of formula R¹Si(OR²)₃, wherein R¹ is a lower alkyl group and R² is a methyl group, and phenyltrimethoxysilane, and further comprising
(C) a silicate selected from the group consisting of an methylorthosilicate, ethylorthosilicate, ethylpolysilicate and colloidal silica dispersed in a lower alkanol; and
(D) acid selected from the group consisting of boric acid and boric acid dissolved in a lower alkanol.

20. The non-aqueous coating composition according to claim 15, wherein component (B) comprises a titanium alcoholate.

21. The non-aqueous coating composition according to claim 20, wherein component (B) comprises a titanium alcohholate and component (D) comprises boric acid.

22. The non-aqueous coating composition according to claim 15, wherein component (C) comprises at least one of ethylorthosilicate and ethylpolysilicate.

23. The non-aqueous coating composition according to claim 15, which comprises a mixture of methyltrimethoxysilane, phenyltrimethoxysilane, tetraisopropoxytitanate, ethylpolysilicate; and boric acid.

24. The non-aqueous coating composition according to claim 23, which comprises from about 15 to about 20 parts by weight of methyltrimethoxysilane, from about 1 to about 5 parts by weight of phenyltrimethoxysilane, from about 0.2 to about 0.5 parts by weight of tetraisopropoxytitane, from about 0.2 to about 1 part by weight of ethylpolysilicate, and from about 0.1 to about 1 part by weight of boric acid.

25. The non-aqueous coating composition according to claim 1 which further comprises
(D) acid component selected from the group consisting of boric acid and boric acid dissolved in a lower alkanol; and wherein component (A) comprises a mixture of silane compounds of formula (1) wherein said mixture includes γ-glycidyloxypropyltrimethoxysilane.

26. The non-aqueous coating composition according to claim 25, which further comprises (C) a silicate component selected from the group consisting of methylorthosilicate, ethylorthosilicate, ethylpolysilicate and colloidal silica dispersed in lower alkanol.

27. The non-aqueous coating composition according to claim 25, wherein component (A) comprises a mixture of a silane of the formula R¹Si(OR²)₃, wherein R¹ is a lower alkyl group and R² is a methyl group, and phenyltrimethoxysilane.

28. The non-aqueous coating composition according to claim 25, wherein component (B) comprises a titanium alcoholate.

29. The non-aqueous coating composition according to claim 25, wherein component (A) comprises a mixture of methyltrimethoxysilane and phenyltrimethoxysilane; component (B) comprises tetraisopropoxytitanate and component (D) comprises boric acid.

30. The non-aqueous coating composition according to claim 29, which comprises from about 15 to about 20 parts by weight of methytrimethoxysilane, from about 1 to about 5 parts by weight of phenyltrimethoxysilane, from about 0.2 to about 0.5 parts by weight of tetraisopropoxytitanate, from about 0.1 to about 1 part by weight of boric acid, and from about 0.3 to about 3 parts by weight of glycidyloxypropyltrimethoxysilane.

31. The non-aqueous coating composition according to claim 29, wherein component (C) comprises ethylorthosilicate.

32. The non-aqueous coating composition according to claim 31, which comprises from about 15 to about 20 parts by weight of methyltrimethoxysilane, from about 1 to about 5 parts by weight of phenyltrimethoxysilane, from about 0.2 to about 0.5 parts by weight of tetraisopropoxytitanate, from about 0.2 to about 1 parts by weight of ethylorthosilicate, from about 0.1 to about 1 parts by weight of boric acid, and from about 0.3 to about 3 parts by weight of γ-glycidyloxypropyltrimethoxysilane.

33. The non-aqueous coating composition according to claim 1, further comprising
(F) finely divided solid lubricant.

34. The non-aqueous coating composition according to claim 33, wherein component (A) comprises a mixure of the formula R¹Si(OR²)₃, wherein R¹ is a lower alkyl group and R² is a methyl group, and phenyltrimethoxysilane.

35. The non-aqueous coating composition according to claim 33, wherein component (B) comprises a titanium alcoholate.

36. The non-aqueous coating composition according to claim 33, wherein component (F) is selected from the group consisting of graphite, molybdenum disulfide, polytetrafluoroethylene and mixtures thereof.

37. The non-aqueous coating composition according to claim 36, wherein component (A) comprises a mixture of methyltrimethoxysilane and phenyltrimethoxysilane; component (B) comprises at least one of tetrabutoxytitanate and tetraisopropoxytitanate.

38. The non-aqueous coating composition according to claim 37, which comprises from about 15 to about 20 parts by weight of methyltrimethoxysilane, from about 1 to about 5 parts by weight of phenyltrimethoxysilane, from about 0.2 to about 0.5 parts by weight of at least one metal alcoholate, and from about 2.5 to about 20 parts by weight of finely divided solid lubricant.

39. The non-aqueous coating composition according to claim 1, wherein component (A) comprises a mixture of methyltrimethoxysilane and butyltrimethoxysilane.

40. The non-aqueous coating composition according to claim 1, wherein component (A) comprises a mixture of phenyltrimethoxysilane, dimethyldimethoxysilane and diphenyldimethoxysilane.

41. The non-aqueous coating composition according to claim 1, wherein component (A) comprises a mixture of methyltrimethoxysilane and dimethyldimethoxysilane.

42. The non-aqueous coating composition according to claim 1, wherein component (A) comprises a mixture of methyltrimethoxysilane and phenyltrimethoxysilane, and wherein component (B) comprises (i) vinyltriacetoxysilane.

43. The non-aqueous coating composition according to claim 1, wherein component (A) comprises a mixture of methyltrimethoxysilane, butyltrimethoxysilane and N-(2-aminoethyl)-3-aminopropyltrimethoxysilane.

44. The non-aqueous coating composition according to claim 1, wherein component (A) comprises a mixture of methyltrimethoxysilane, phenyltrimethoxysilane, and N-(2-aminoethyl)-3-aminopropyltrimethoxysilane, and wherein component (B) comprises (i) vinyltriacetoxysilane.

45. The non-aqueous coating composition according to claim 1, wherein component (A) comprises a mixture of methyltrimethoxysilane and diphenyldimethoxysilane.

46. The non-aqueous coating composition according to claim 1, wherein component (A) comprises a mixture of methyltrimethoxysialne, propyltrimethoxysilane, and N-(2-aminoethyl)-3-aminopropyltrimethoxysilane, and wherein component (B) comprises vinyltriacetoxy silane.

47. The non-aqueous coating composition according to claim 1, wherein component (B) comprises an alcoholate of titanium or aluminum.

48. The non-aqueous coating composition according to claim 47, wherein component (B) comprises at least one compound selected from the group consisting of tetrabutoxytitanate, tetraisopropoxytitante, and triisopropoxyaluminate.
